(19) United States
(12) Patent Application Publication
(10) Pub. No.: US 2025/0179266 A1
(43) Pub. Date: Jun. 5, 2025

(54) Tire Compositions with Antiozonants and Carbon Nanotubes

(71) Applicant: Molecular Rebar Design, LLC, Austin, TX (US)

(72) Inventors: August Krupp, Austin, TX (US); Kurt W. Swogger, Austin, TX (US)

(21) Appl. No.: 18/970,465

(22) Filed: Dec. 5, 2024

Related U.S. Application Data
(60) Provisional application No. 63/606,358, filed on Dec. 5, 2023.

(51) Int. Cl. C08K 3/04; B60C 1/00; C08K 5/18; C08K 9/04; C08L 7/00; C08L 9/00

(52) U.S. Cl. CPC C08K 3/041; B60C 1/0025; C08K 5/18; C08K 9/04; C08L 7/00; C08L 9/00; C08K 2201/004; C08L 2205/02; C08L 2310/00; C08L 2312/02

(57) ABSTRACT

The application pertains in some embodiments to a composition comprising a plurality of discrete carbon nanotubes, a polymer, and/or an antiozonant wherein a plurality means more discrete nanotubes than not and/or exfoliated useful for replacing all, or a portion of, typical antiozonants or antioxidants in tires or rubber parts.

### CROSS REFERENCE TO RELATED APPLICATIONS

This application claims priority to 63/606,358 filed Dec. 5, 2023 which application is incorporated by reference. This application is also related to U.S. patent application U.S. 63/328,429 filed Apr. 7, 2022 and U.S. Ser. No. 18/132,299 filed Apr. 7, 2023 entitled “Compositions with carbon nanotubes for low hysteresis elastomers”, both of which are incorporated herein by reference. The application also incorporates by reference U.S. Pat. Nos. 9,212,273, 9,353,240, 9,422,413, 9,493,626, 9,636,649, and 11,014,815.

### GOVERNMENT SUPPORT

This material is based upon work supported by the U.S. Environmental Protection Agency under contract no. 68HERC24C0030.

### FIELD OF INVENTION

The Molecular Rebar, when combined with a lesser concentration of 6PPD, or a less-environmentally-hazardous antiozonant, like 77PD, will maintain tire lifetime due to ozonolysis, but reduce the environmental concern related to tires and their anti-degradant byproducts. A reduced or totally removed concentration of 6PPD in the sidewall compound will inherently decrease the bioavailability of 6PPD from tires in the environment. Replacing 6PPD with a safer antiozonant, like 77PD, or removing any of the PD/PPD class of antiozonants will reduce environmental concerns related to fish kill. If the total concentration of 6PPD/77PD in a tire can be reduced by 80%, the migration of antiozonant reaction products to the environment could be reduced by up to 414 kilotonnes/year. Molecular Rebar carbon nanotubes enables removal of antiozonants from elastomer compounds, like tire sidewalls, greatly reducing concerns for human health and the environment.

### BACKGROUND AND SUMMARY OF INVENTION

Antiozonants, like N1-(4-Methylpentan-2-yl)-N4-phenylbenzene-1,4-diamine (6PPD), are used in rubber compounds to prevent degradation of polymer chains through ozonolysis. When ozone (O₃) reacts with the double bonds in common tire polymers, like natural rubber (NR), polybutadiene rubber (BR), and styrene butadiene rubber (SBR), an ozonide is formed. The ozone reaction with rubber compounds only occurs at the surface of the rubber, usually less than 500 μm of depth. Under strain, those ozonides decompose, and the polymer chain is cleaved.

Once the polymer chains have been cleaved, micro-cracks are created. The initial microcracks from chain scission are very small, varying between 0.01 and 1 μm in length³. Through crack propagation mechanisms, where energy under high strain is focused at the crack tip causing growth, the microcracks coalesce together, forming much larger cracks⁴.

Eventually, those cracks combine to cause catastrophic material loss, which can lead to blowouts from major cracks or increased abrasion from loss of larger particles.

Antiozonants are key in preventing ozonides from forming within rubber tire compounds, mostly by sacrificial means where the antiozonant transforms into other products⁵. Antiozonants are commonly paired with antioxidants, like 2,2,4-Trimethyl-1,1-dihydroquinoline (TMQ) and waxes of varying molecular weights, but those antioxidants cannot retain rubber compound qualities without the presence of an antiozonant. Not all antiozonants are created equal—some are better than others at meeting the three primary criteria that result in a good antiozonant, from Colvin⁶:
1. The migration rate provides the right balance between too fast (where the antiozonant is depleted before the tire lifetime is complete) and too slow (where insufficient ozone protection is available)
2. The rate of reaction with ozone is sufficient for protection.
3. The rate of reaction with oxygen is such that antiozonant is not depleted during tire lifetime.

6PPD suitably meets these criteria and is currently the most popular and best performing antiozonant. Other known antiozonants have some drawbacks in comparison to 6PPD, as outlined below:
7PPD/7PD—Used up more rapidly than 6PPD, does not last as long at similar loadings.
DPPD—Lower levels of reactivity & slower migration characteristics than 6PPD.
IPPD—Lower rubber solubility & slower migration characteristics than 6PPD.
CPPD—Used up more rapidly than 6PPD, does not last as long at similar loadings.

In addition, each of these PPD-family antiozonants have the same basic chemical structure—all of them will form a quinone when reacted with ozone.

Current mechanisms suggest that 6PPD-quinone is harmful to fry and smolt salmon based on loss of integrity in cell-cell adhesions in the blood-brain barrier (BBB) and endothelial junctions, caused by 6PPD-quinone penetration through the BBB and capillary leaks⁸. End-group structures are the dominant force for movement of molecules in matrices, and because the reaction product quinone molecules are substantially different, it is assumed that not all PPD-quinones have the same level of bio-movement. A study regarding biotoxicity of IPPD demonstrates concerning levels of zebra fish toxicity⁹, while 77PD is of lesser environmental concern than any of the other PPDs above¹⁰, which corresponds well to prevalent theories regarding the dangers of benzene ring end structures. The primary arguments from the tire industry against shifts from 6PPD to these other, likely safer, PPDs—such as 77PD—have been focused around their much shorter lifetimes due to higher migration rates¹¹.

Antiozonants are utilized in every portion of rubber compound in a tire, mostly due to the fact that they are highly mobile and will migrate from areas of greater concentration to lesser concentration. As an example, ozonolysis rarely has a meaningful impact on tire treads because the treads wear more quickly than ozonolysis occurs, but antiozonants are still included in tire tread formulations so that they did not scavenge the antiozonants from the tire sidewall compounds. The key to reducing overall concentration of antiozonants in the tire is to focus on improvements in components that are long-lasting and do not have a high wear profile, like the tire sidewall rubber component. Additionally, if the antiozonants can be less mobile in leeching from the tire compounds, antiozonants can be added only to the sidewall compounds, reducing overall antiozonant concentration in the tire. Currently, there is no commercially available alternative to the use of antiozonants for tires—antiozonants, and 6PPD especially, are a requirement to insure tire longevity and safety, per the U.S. Tire Manufacturing Association (USTMA).

In conclusion, it is likely that other a removal of, or replacement with alternative, PPDs may be safer than 6PPD, with the frontrunner being 77PD, but more ozonolysis and polymer chain scission will occur, reducing overall tire lifetime. Improvements in the reduction of 6PPD concentration or switch with 77PD should focus on the sidewall, as it has the highest performance requirement for antiozonants in tire compound components.

Carbon nanotubes (CNTs) have been hailed as the next revolution in materials science for nearly thirty years, but their commercial potential is only now beginning to be realized, mostly in energy storage/batteries. A barrier has been the tendency of CNTs to clump, which greatly diminishes their beneficial properties. For example, CNTs as manufactured on the large scale exist in a bundled form, which are low surface area, inefficient at reinforcing, and have minimal beneficial materials' properties.

Molecular Rebar Design, LLC (MRD) has developed a breakthrough process and capability that solves this clumping problem. Through MRD's technology, these bundled CNTs are cleaned of catalytic residue, chemically functionalized, and de-bundled into individual nanotubes. The individuality of the nanotubes creates a high surface area, while the chemical functionality allows for improved bonding to the composite matrix, both of which work in tandem to improve composite properties. These discrete nanotubes are called MOLECULAR REBAR® (MR). MR makes many of the long-hypothesized nanotube benefits practical, such as creating better batteries, coatings, 3D printed parts, and rubber tires.

Unlike ordinary CNTs, Molecular Rebar are discrete, individual, and can be chemically functionalized. Individual carbon nanotubes are far more effective as a reinforcing additive than their clumped counterparts—a greater volume of the part is reinforced on a weight basis, and the carbon nanotubes provide a distributed lattice work of reinforcement. The MR impedes crack growth, greatly improving wear resistance.

MRD has utilized non-functional and functional Molecular Rebar in rubber compounds to achieve improved physical properties, such as cut & chip and abrasion resistance without detrimentally affecting rolling resistance, or energy loss during motion. MRD has been working with leading rubber parts, goods, and tire manufacturers for nearly five years on specialized, higher-value, applications, such as off-the-road (OTR) tires and sacrificial wear-resistant mining equipment liners. These parts & tires utilize a highly filled carbon black or silica composite for the tread compound. MR CNTs bind with the polymer matrix, either by physisorption or by covalent coupling (silane)—improving wear resistance and rolling resistance without effecting other critical properties.

MRD has generated substantial datasets demonstrating the use of its Molecular Rebar to improve crack-propagation-related materials properties. The MR is delivered through various means, all of which give significant crack propagation resistance improvements, with the maximum improvement at ˜50%. Single-edged notch tear tests primarily measure tear/crack propagation resistance.

Molecular Rebar has been proven to greatly enhance crack propagation resistance in elastomers—far in excess of what typical reinforcing fillers are capable of—like carbon black and silica.

The use of lesser quantities of 6PPD, or use of a faster migrating (less effective), but likely safer PPD—like 77PD—reduces the environmental concern of antioxidants in rubber, but will cause more polymer chain scission, microcracks, and eventual failure-causing cracks—reducing overall rubber lifetime. With MOLECULAR REBAR® (MR) carbon nanotubes, those microcracks will be halted—enabling use of less 6PPD or use of safer antioxidants, maintaining tire lifetime and reducing environmental concern over anti-degradants in the tire. Furthermore, preliminary experiments show antiozonants' water leeching rate are slower with MR, potentially slowing its release to the environment and yet having more antiozonants available to absorb ozone. With both of these aspects regarding the use of MR, a new approach to dealing with this type of ozone degradation is invented.

However, until this application, no reinforcing filler—including this Molecular Rebar carbon nanotube, has been thought to be capable of suppressing microcracks caused by ozonation, effectively reducing the need for antiozonants in crosslinked elastomers. This novel antiozonant replacement/reduction concept & resultant composition is differentiated from prior Molecular Rebar inventions in its unexpected ability to completely remove antiozonants from elastomer formulations, while maintaining tire longevity & safety indicators.

### BRIEF DESCRIPTION OF THE DRAWINGS

FIG. 1 shows the rate of migration into solution.

FIG. 2 shows sidewall compound properties.

FIG. 3A shows images of samples.

FIG. 3B shows images of samples.

FIG. 4 shows ozone crack distribution.

FIG. 5 shows Mini-DeMattria results.

### DETAILED DESCRIPTION OF THE INVENTION

With the addition of the MR to sidewall tire compounds, the crack propagation resistance of the sidewall rubber compound will be improved. A typical sidewall compound has been compared with sidewall compounds from multiple sources and found to be suitable for experimentation in this example. Noticeably, the loading of 6PPD is 4.5 parts-per-hundred-rubber (PHR).

| | | |
|---|---|---|
| Compound Material | Grade | PHR |

| | |
|---|---|
| Natural Rubber | 50 |
| Polybutadiene | 50 |
| Peptizer | 0.2 |
| N330 Carbon Black | 45 |
| TDAE Process Oil | 3.5 |
| Paraffinic Wax | 2 |
| Microcrystalline Wax | 1 |
| Tackifying Resin | 2 |
| Polymerized trimethyl-1,2- | 1.5 |
| dihydroquinoline (TMQ) | |
| Dimethylbutyl-N′-phenyl-p- | 4.5 |
| phenylenediamine (6PPD) | |
| Zinc Oxide | 1 |
| Stearic Acid | 1 |
| t-butyl-2-benzothaizole- | 0.95 |
| sulfenamide (TBBS) | |
| Sulfur | 1 |
| N-(cyclohexylthio)-phthalimide | 0.25 |
| (CTP) | |

| | |
|---|---|
| Total: | 163.90 |

### EXAMPLE 1

The sidewall compound is modified as follows in three different fashions:
1. Addition of MR functionalized with —OH/—COOH groups at ˜2.5 wt % by weight of CNT with a reduction of 2 PHR in 6PPD
2. Addition of amine-functionalized MR at ˜1.5 wt % by weight of CNT with a reduction of 2 PHR in 6PPD
3. Addition of <0.25 wt % —OH/—COOH functional MR with a replacement of 6PPD with 77PD

| Ingredient (Measured in | Formula 1: | Formula 2: | Formula 3: | Formula 4: |
|---|---|---|---|---|
| PHR) | Control | OMR/6PPD | NMR/6PPD | MR/77PD |
| Natural Rubber | 50 | 50 | 50 | 50 |
| Polybutadiene | 50 | 50 | 50 | 50 |
| Peptizer | 0.2 | 0.2 | 0.2 | 0.2 |
| N330 Carbon Black | 45 | 37 | 37 | 37 |
| MR with —OH/—COOH | | 3 | | |
| MR with NH2 | | | 3 | |
| MR | | | | 3 |
| TDAE Oil | 3.5 | 3.5 | 3.5 | 3.5 |
| Paraffinic Wax | 2 | 2 | 2 | 2 |
| Microcrystalline Wax | 1 | 1 | 1 | 1 |
| Tackifying Resin | 2 | 2 | 2 | 2 |
| TMQ | 1.5 | 1.5 | 1.5 | 1.5 |
| 6PPD | 4.5 | 2.5 | 2.5 | |
| 77PD | | | | 4.5 |
| Zinc Oxide | 1 | 1 | 1 | 1 |
| Stearic Acid | 1 | 1 | 1 | 1 |
| TBBS | 0.95 | 0.95 | 0.95 | 0.95 |
| Sulfur | 1 | 1 | 1 | 1 |
| CTP | 0.25 | 0.25 | 0.25 | 0.25 |
| TOTAL PHR | 163.90 | 156.90 | 156.90 | 158.90 |

The formulations above are mixed in accordance to typical compounding procedures, and then crosslinked in various article forms for testing. The application incorporated by reference has described methodologies for these processes, along with many of the referenced citations, including the inventor's previous publications and granted patents. The sidewall compound is then tested according to the following key properties related to estimated tire life due to ozonation (in addition to typical other properties), with data indexed to the control compound:
1. Ozone Resistance—measured by the quantity & size of micro-cracks that appear in an ozone aging test: ASTM D1149.
2. Intrinsic Strength—Pre- and post-ozone aging test on known compounds. Generated from tensile, tear, and intrinsic strength analyzer testing. Identifies changes in sample strength due to material properties changes or ozonolysis.
3. Fatigue Lifetime—An expectation of field lifetime, simulated in the laboratory by flex fatigue testing using a modified DeMattia test on ozone aged samples, as well as standard flex fatigue testing using a dynamic mechanical analyzer (DMA).

| Test (Indexed to Control & | Formula 1: | Formula 2: | Formula 3: | Formula 4: |
|---|---|---|---|---|
| Indexed to Unaged) | Control | OMR/6PPD | NMR/6PPD | MR/77PD |
| Tensile Strength - unaged | 100 | 104 | 101 | 98 |
| Tensile Strength - aged | 70 | 72 | 70 | 69 |
| 200% Modulus - unaged | 100 | 100 | 100 | 100 |
| 200% modulus - aged | 120 | 122 | 118 | 115 |
| Tear Strength - Die C - | 100 | 120 | 121 | 118 |
| unaged | | | | |
| Tear Strength - Die C - aged | 65 | 76 | 68 | 65 |
| Flex Fatigue Lifetime - | 100 | 135 | 124 | 115 |
| unaged | | | | |
| Flex Fatigue Lifetime - aged | 85 | 92 | 88 | 84 |
| Ozone Resistance | 100 | 102 | 98 | 99 |
| Intrinsic Strength - unaged | 100 | 130 | 135 | 128 |
| Intrinsic Strength - aged | 70 | 73 | 79 | 70 |

MR with both chemical moieties tested, hydroxyl and carboxyl groups, along with amine groups, allow for a lesser quantity of 6PPD to used and still maintain, or improve, critical properties. When using a full loading of 77PD to replace 6PPD, along with a less functional, but still discrete, carbon nanotube Molecular Rebar, the expected lifetime of the compound is maintained. This is not typical, as usually 77PD reduces antiozonant capability, reducing expected tire sidewall compound lifetime.

Migration of antiozonant through time can also be used to quantify the mobility of the antiozonants when the Molecular Rebar are present with any chemical functionality. A modified version of ASTM 7210 and ASTM D6953, originally intended to quantify antioxidants in thermoplastics, can be used to simulate and measure the migration characteristics of antiozonants in tire compounds over the lifetime of the tire.

### EXAMPLE 2

Molecular Rebar carbon nanotubes with different chemical functionalities were integrated into a similarly simplistic rubber sidewall compound that was sulfur crosslinked. The compound formulations performed in this Example 2 are shown in below. Note that although the initial APTES MR content in the 1st mix step was of lower content, it was made up for in the dilution of mix step 2 to equal that of the other MR and carbon black concentrations.

| | | Control | NOMR | MR (MA776B) | APTES MR |
|---|---|---|---|---|---|
| Material | Mix Step | PHR | PHR | PHR | PHR |
| Natural Rubber (TSR 10 or CV60) | 1 | 100 | 100 | 100 | 100 |
| Carbon Black N330 | 1 | 25 | | | |
| NOMR (from wetcake) | 1 | | 25 | | |
| MR (MA 776B) (from wetcake) | 1 | | | 25 | |
| APTES MR (from wetcake) | 1 | | | | 9.2 |
| Master Batch - 1st Pass | | 22.7 | 22.7 | 22.7 | 56.25 |
| Natural Rubber (TSR 10 or CV60) | 2 | 81.84 | 81.84 | 81.84 | 48.49 |
| Antiozonant 6PPD | 2 | 4.5 | 4.5 | 4.5 | 4.5 |
| Zinc Oxide | 2 | 0.95 | 0.95 | 0.95 | 0.95 |
| Sulfur | 2 | 1 | 1 | 1 | 1 |
| Specific Gravity | | 0.961 | 0.972 | 0.972 | 0.973 |

The MR functionalities tested in both experiments were:
1. “NOMR”—an unoxidized and discrete (individualized) multiwall carbon nanotube (MWCNT)
2. “MR (MA776B)”—an oxidized (>2 wt %<3 wt %) and individualized MWCNT
3. “APTES MR”—an oxidized, and then subsequently functionalized with (3-Aminopropyl)triethoxysilane (APTES), MWCNT that is also individualized.

These functionalities were chosen to provide a range of polarity, where the NOMR is the least polar, the APTES MR is of medium polarity, possessing an amine end group, and the MR (MA776B) is oxidized with —OH and —COOH groups.

All three functionalities were integrated into the elastomer compounds in the same fashion, using a wetcake masterbatch method where the MWCNTs exist in a discrete and dispersed state in a de-watered “cake” aqueous solution, which is then mixed into the elastomer—driving off the water and resulting in an individualized dispersion of the Molecular Rebar MWCNTs in the polymer.

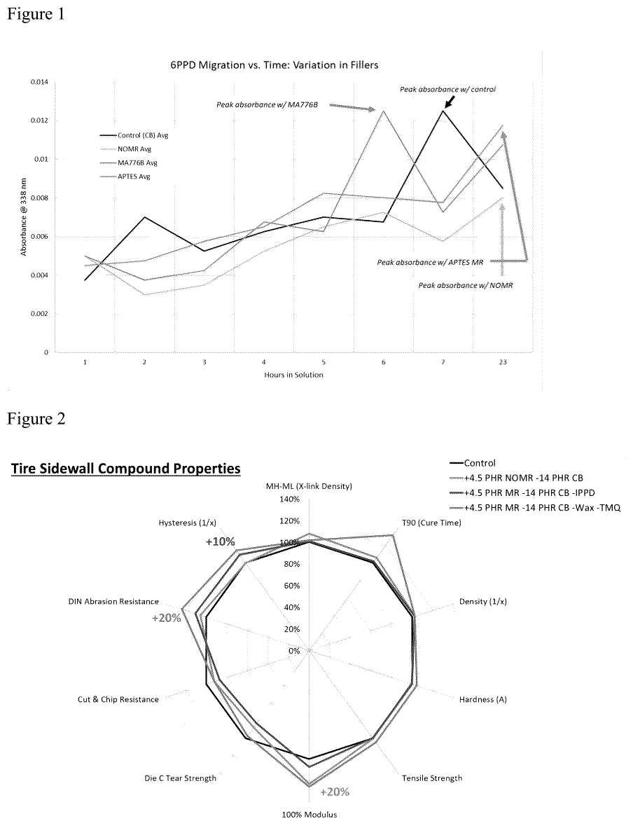

The first compound experiment resulted in NOMR & APTES MR delaying the peak migration of 6PPD into water by 16+ hours, while the oxidized MR (MA776B) had an earlier spike in total solution absorbance than the control, containing carbon black. Lower absorbance indicates reduced concentration of 6PPD in the aqueous solution. If rank ordered, the rate of 6PPD migration into solution fits the rank of polarity, with NOMR having the least absorbance measured, followed by the APTES MR, followed by the oxidized MR (MA776B). This data is shown in graphical format in FIG. 1.

The results of this 6PPD emissions study demonstrate that the use of the MR with both oxidized and APTES functionalization has a delayed migration of 6PPD aqueous release compared to that of the industry control with carbon black. This indicates that the MR carbon nanotubes reduce migration rates of the 6PPD within the rubber compound, and to the surrounding environment.

### EXAMPLE 3

The MRD team performed a 16-formulation larger-scale (1.6 L Banbury) compound study with the full sidewall formulation to evaluate the effects of MR delivered via both natural rubber (NR) and polybutadiene (PBD or BR) rubber masterbatches. These formulations used the carbon black (CB) replacement ratio and Molecular Rebar® (MR) loading of +4.5MR −14CB to match modulus. These experimental compounds provided initial physical property data and enough experimental material for ozone aging & related testing.

The formulations where MR is delivered via natural rubber are shown below below, representing one-half of the experimental compounds. Two controls exist in the experimental design, one with no experimental changes and one where 4.5 PHR of the carbon black is processed in the same manner as the MR masterbatch, negating small-scale processing effects. Formulation 6: Control CB MB will be used as the control compound for measurements—controlling for the processing effects that in the long term will be nonexistent at scale. Data for these controls are averaged together to improve statistical certainty.

| | | | | | | | | NOMR + | MR + |
|---|---|---|---|---|---|---|---|---|---|
| | | | | | NOMR + | MR + | | 4.5MR − | 4.5MR − |
| | | | NOMR + | MR + | 4.5MR − | 4.5MR − | | 16CB − | 14CB − |
| | | | 4.5MR − | 4.5MR − | 14CB − | 14CB − | Control | Wax − | Wax − |
| | Mix | Control | 14CB | 14CB | IPPD | IPPD | CB MB | TMQ | TMQ |
| Material | Step | PHR | PHR | PHF | PHR | PHR | PHR | PHR | PHR |
| Carbon Black NR Masterbatch | 1 | | | | | | 22.7 | | |
| (20 wt %) | | | | | | | | | |
| NOMR NR Masterbatch (20 wt %) | 1 | | 22.7 | | 22.7 | | | 22.7 | |
| MR NR Masterbatch (MA776B) | 1 | | | 22.7 | | 22.7 | | | 22.7 |
| (20 wt %) | | | | | | | | | |
| Natural Rubber (TSR 10 or CV60) | 1 | 50 | 31.84 | 31.84 | 31.84 | 31.84 | 31.84 | 31.84 | 31.84 |
| Polybutadiene Rubber | 1 | 50 | 50 | 50 | 50 | 50 | 50 | 50 | 50 |
| Peptizer (Pepton 44) | 1 | 0.2 | 0.2 | 0.2 | 0.2 | 0.2 | 0.2 | 0.2 | 0.2 |
| Carbon Black (N330) | 1 | 45 | 31 | 31 | 31 | 31 | 40.5 | 31 | 31 |
| Process Oil (TDAE-Viva tec 500) | 1 | 3.5 | 3.5 | 3.5 | 3.5 | 3.5 | 3.5 | 3.5 | 3.5 |
| Paraffinic Wax (Akrowax 130) | 1 | 2 | 2 | 2 | 2 | 2 | 2 | 3 | 3 |
| Microcrystalline Wax | 1 | 1 | 1 | 1 | 1 | 1 | 1 | 1.5 | 1.5 |
| (Akrowax 23 or 195) | | | | | | | | | |
| Tackifying Resin (HR-801) | 1 | 2 | 2 | 2 | 2 | 2 | 2 | 2 | 2 |
| TMQ/DQ | 1 | 1.5 | 1.5 | 1.5 | 1.5 | 1.5 | 1.5 | 2.25 | 2.25 |
| Antiozonant 6PPD | 1 | 4.5 | 4.5 | 4.5 | | | 4.5 | | |
| Antiozonant IPPD (PD-1) | 1 | | | | 4.5 | 4.5 | | | |
| Zinc Oxide | 1 | 1 | 1 | 1 | 1 | 1 | 1 | 1 | 1 |
| Stearic Acid | 1 | 1 | 1 | 1 | 1 | 1 | 1 | 1 | 1 |
| Master Batch-2nd Pass | | 161.7 | 152.24 | 152.24 | 152.24 | 152.24 | 161.74 | 149.99 | 149.99 |
| TBBS Accelerator | 2 | 0.95 | 0.95 | 0.95 | 0.95 | 0.95 | 0.95 | 0.95 | 0.95 |
| Sulfur | 2 | 1 | 1 | 1 | 1 | 1 | 1 | 1 | 1 |
| CTP/PVI Retarder | 2 | 0.25 | 0.25 | 0.25 | 0.25 | 0.25 | 0.25 | 0.25 | 0.25 |
| Specific Gravity | | 1.107 | 1.076 | 1.076 | 1.078 | 1.078 | 1.103 | 1.076 | 1.076 |

MRD's experimental compound study demonstrated that the addition of either type of MR (oxidized or non-oxidized) via a natural rubber wet-cake masterbatch approach provides slightly superior properties than the addition of MR via a polybutadiene rubber masterbatch. Interestingly, the use of non-oxidized NOMR provided superior benefits over the oxidized MR when there was no change to the 6PPD loading, while when 6PPD was removed in favor of IPPD or increased waxes & TMQ, the oxidized MA776B MR provided a better mix of properties. This experiment confirmed MRD's expectations on the experimental samples later provided to subcontractors for ozone-related testing:
1. Control compound—representative of state-of-the-art sidewall, controlled for small-scale processing.
2. +4.5 PHR NOMR −14 PHR CB—14 PHR of carbon black is replaced with 4.5 PHR of non-oxidized MR, 6PPD content remains the same as the control. This sample is intended to provide a reference point on the physical reinforcing effects of the MR before/during/after ozone aging, informing the hypothesis that MR can interrupt ozonolysis-related cracks.
3. +4.5 PHR MR −14 PHR CB-IPPD—6PPD is replaced with IPPD, where if the ozone resistance is the same as the control compound, additional credence is given to the hypothesis that MR with an inferior antiozonant may be an implementable solution. Oxidized MR replaces carbon black at the same ratio as the other compounds.
4. +4.5 PHR MR −14 PHR CB-Wax-TMQ—6PPD is replaced with an additional 50% of microcrystalline wax, paraffinic wax, and antioxidant TMQ. Oxidized MR replaces carbon black at the same ratio as the other compounds.

The physical properties of these compounds are shown in the radar plot in FIG. 2, measuring critical tire compound properties.

The Molecular Rebar samples demonstrated matched properties on critical processing and physical parameters—like MH-ML & Hardness—and were observed to have improved properties relating to crack-growth metrics, like 100% Modulus, DIN Abrasion Resistance, and Hysteresis. Die C Tear Strength and Cut & Chip Resistance were slightly lower in this phase of the experiment with MR, but the results were within the range of error of the tests.

A brief description and explanation of the ozone aging and ozone resistance tests that were performed follows:

ASTM D 1149: A measure of ozone resistance, where vulcanized rubber samples are exposed to an atmosphere containing a known level of ozone. In Method B, Proc. B1, the samples undergo a static strain of 20%.

ARDL 8118: Mini-DeMattia: Samples repeatedly undergo flexural extension. The number of cycles vs. crack growth is measured, and a resistance to crack growth, and thus expected lifetime, is determined.

Intrinsic Strength Analyzer: A complicated system that determines the threshold fracture mechanical strength—i.e., the mechanical fatigue threshold—of a polymer network. The mechanical fatigue threshold of the sidewall compounds directly relates to their expected lifetimes.

The results for ASTM D 1149: Ozone Resistance, Method B, Procedure B1 are shown below.

TABLE 1
Ozone ratings after static ozone exposure

| | | Ozone rating after |
|---|---|---|
| | | exposure time, zero |
| | | indicating no cracking |
| Compound | Specimen # | 72 hrs |
| 2 | 1 | Cracks |
| | 2 | Cracks |
| | 3 | Cracks |
| 5 | 1 | 0 |
| | 2 | 0 |
| | 3 | 0 |
| 6 | 1 | Cracks |
| | 2 | Cracks |
| | 3 | Cracks |
| 8 | 1 | 0 |
| | 2 | 0 |
| | 3 | 0 |

Sample 2: +4.5 PHR NOMR −14 PHR CB (w/6PPD)

Sample 5: +4.5 PHR MR −14 PHR CB-IPPD

Sample 6: Control Compound with 6PPD

Sample 8: +4.5 PHR MR −14 PHR CB-Wax-TMQ

NOMR: non-oxidized Molecular Rebar

MR: oxidized Molecular Rebar

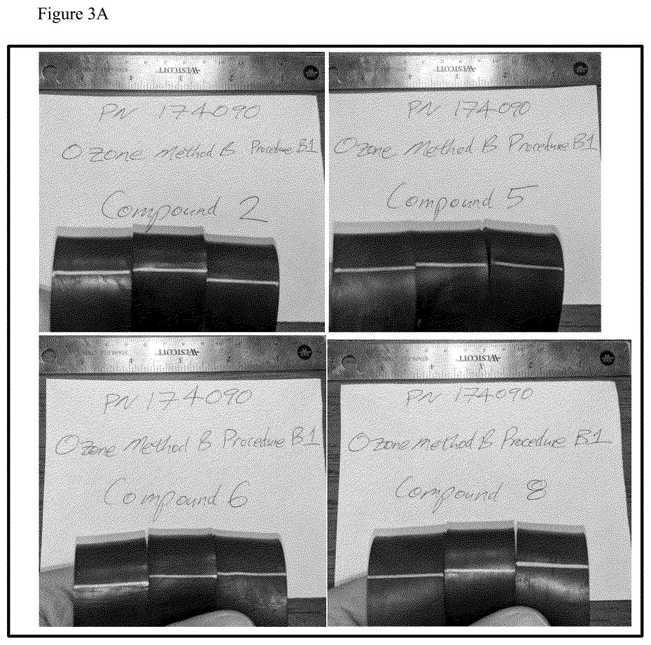

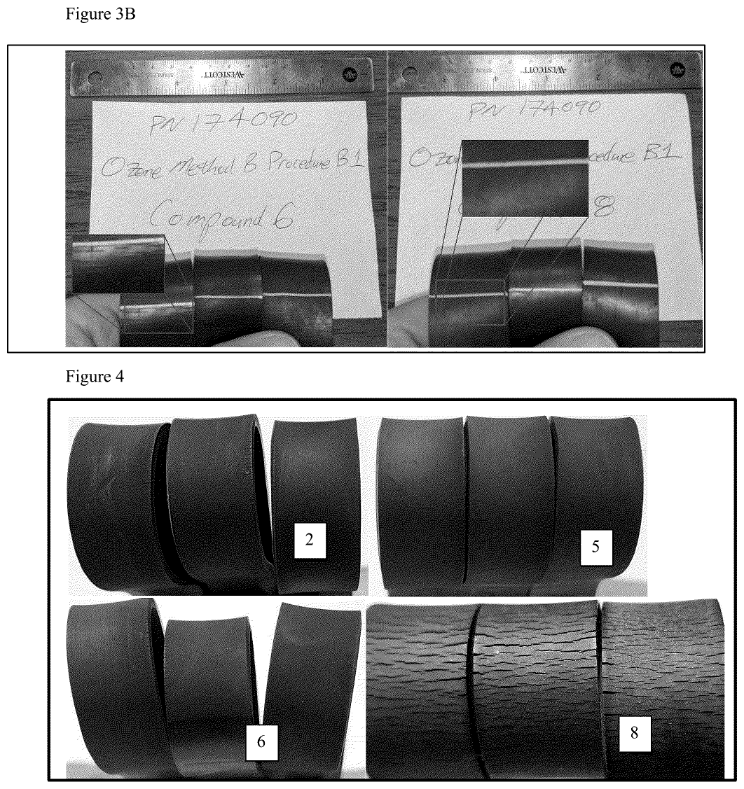

The primary interesting finding for these test results is that while either 6PPD sample did not pass the ozone resistance test, two of the alternatives did pass; sample 8 which used no chemicals of the PPD class, only the Molecular Rebar nanotubes and a higher loading of TMQ (antioxidant) and waxes (blooming protective layer), and the other which passed, sample 5, used MR and another PPD, rather than 6PPD. Images of all of the samples are shown in FIGS. 3A and 3B. An image in FIG. 3B with a zoomed in section of both the failed Control sample (typical sidewall compound with 6PPD) and the sample using no PPDs are shown to demonstrate the level of cracking observed.

The results for ASTM D 1149: Ozone Resistance—Method A, Procedure A1, Dynamic Tensile Elongation are shown below in FIG. 4.

| | | Ozone rating after exposure time^{&} | | |
|---|---|---|---|---|
| Compound | Specimen # | 24 hrs | 48 hrs | 70 hrs |
| 2 | 1 | 1 | 2 | 3 |
| | 2 | 1 | 2 | 3 |
| | 3 | 1 | 2 | 3 |
| 5 | 1 | 0 | 1 | 2 |
| | 2 | 0 | 1 | 2 |
| | 3 | 0 | 1 | 2 |
| 6 | 1 | 0 | 1 | 2 |
| | 2 | 0 | 1 | 2 |
| | 3 | 0 | 1 | 2 |
| 8 | 1 | 3 | 3 | 3 |
| | 2 | 3 | 3 | 3 |
| | 3 | 3 | 3 | 3 |

^{&}Significance of numerical ratings:
—: Status not reported
0: No cracking
1: Cracks visible at 7x magnification
2: Cracks visible to the naked eye
3: Large cracking present

While all samples failed Method A of the ozone resistance test at 70 hrs of test time, at 24 & 48 hrs of test time there were distinguishable differences between the compounds given in the form of the numeric ratings. Images of the post-ozone aged samples are shown below. Note that there is no scale bar or ruler on these, and that the image of sample 8 has a higher magnification than the other samples. The cracks in sample 8 are not substantially larger to the naked eye than those of sample 2, given the same numerical rating.

Ozone crack distribution and length analysis [symbol] was performed on these post-ozone-aged [symbol] samples. The table below summarizes those findings.

| Compound: | 2 | 5 | 6 | 8 |
|---|---|---|---|---|
| Average Crack Length (mm) | 0.114 | 0.038 | 0.088 | 1.157 |
| Std. Dev. Crack Length (mm) | 0.035 | 0.013 | 0.036 | 0.767 |
| Number of Cracks per 1 mm² [symbol] | 29 | 80 | 45 | [symbol] |
| | | | | 1.44 |

Sample 2 (+4.5 PHR NOMR −14 PHR CB (w/6PPD)) had slightly longer cracks but 35% less number of cracks than the control sample (#6) with carbon black and 6PPD alone. This is a realization of the hypothesized benefit of Molecular Rebar—although very small 0.01 and 1 μm in length ozonolysis cracks are forming (not visible at this magnification), they are not coalescing into frequent larger cracks. The longer cracks are likely due to the increased circuitous route required for crack formation with crack-pinning effects of the MR.

Sample 5 (+4.5 PHR MR −14 PHR CB-IPPD)

MR+wax with no 6PPD had much longer cracks but much less number than 6PPD and MR

Sample 8 (+4.5 PHR MR −14 PHR CB-Wax-TMQ)

IPPD showed a large number of small cracks—considered crack nucleants but not coalesced.

These ASTM D1149 ozone resistance results, Methods A & B, show that Molecular Rebar is indeed providing increased resistance to cracking and has the potential to replace 6PPD with alternate formulations, using increased loadings of TMQ & waxes to provide sufficient anti-ozonation resistance in addition to the crack resistance of the MR reducing macro-cracks visible to the naked eye.

Intrinsic Strength Analysis (ISA) results are shown below in summarized tabular format. Higher values for both minimum tearing energy and critical tearing energy are desirable, both pre- and post-ozone aging.

| | | Avg. Min. | | Avg. Critical | |
|---|---|---|---|---|---|
| | | TearingEnergy | | TearingEnergy | |
| | Compound | (J/m\hat{ }2) | Std. Dev. | (J/m\hat{ }2) | Std Dev. |
| Pre-Ozone Aging | #2 | 103.51 | 1.62 | 33518.50 | 394.23 |
| | #5 | 87.23 | 2.0 | 32115.10 | 570.83 |
| | #6 | 90.57 | 1.54 | 28363.30 | 761.11 |
| | #8 | 94.88 | 0.47 | 36570.77 | 363.64 |

| | | Avg. Min. | | Avg. Critical | |
|---|---|---|---|---|---|
| | | TearingEnergy | | TearingEnergy | |
| | Compound | (J/m\hat{ }2) | Std. Dev. | (J/m\hat{ }2) | Std Dev. |
| Post-Ozone Aging(72 hours at 100 | #2 | 79.97 | 3.81 | 34147.60 | 819.92 |
| pphm ozone/40° C.) | #5 | 78.80 | 3.34 | 32234.83 | 290.01 |
| | #6 | 86.89 | 2.68 | 28526.00 | 566.29 |
| | #8 | 126.37 | 1.88 | 34830.83 | 226.58 |

| | | ΔMin. | ΔCritical | |
|---|---|---|---|---|
| | | TearingEnergy | TearingEnergy | |
| | Compound | (J/m\hat{ }2) | (J/m\hat{ }2) | Std Dev. |
| ΔPre-/Post- Ozone Aging | #2 | −23.54 | 629.10 | |
| | #5 | −8.43 | 119.73 | |
| | #6 | −3.68 | 162.70 | |
| | #8 | 31.49 | −1739.93 | |

| | | ΔMin. | | ΔCritical | |
|---|---|---|---|---|---|
| | | TearingEnergy | | TearingEnergy | |
| | Compound | (J/m\hat{ }2) (%) | Std. Dev. | (J/m\hat{ }2) (%) | Std Dev. |
| ΔPre-/Post- Ozone Aging(%) | #2 | −23% | 5% | 2% | 2% |
| | #5 | −10% | 4% | 0% | 1% |
| | #6 | −4% | 3% | 1% | 2% |
| | #8 | 33% | 1% | −5% | 1% |

It is observed that sample 8 (+4.5 PHR MR −14 PHR CB-Wax-TMQ) has the highest average critical tearing energy both pre- and post-ozone aging and has the highest minimum tearing energy post-ozone aging, demonstrating the best physical properties of any compound tested in this category. It is interesting to note that the minimum tearing energy of sample 8 increases with ozone aging, while the other sample's decrease. This indicates some reversal of typical sample behavior with the use of no antiozonant, as compared to samples with antiozonant. The result, although interesting, is not detrimental to performance, as indicated by sample 8's performance in the ISA testing that is superior to all other samples, including the control (compound 6) by a statistically significant margin.

The ISA results, combined with the post-ozone-aged ASTM 1149 Method B crack analysis by MRD, confirm that the Molecular Rebar provides improved micro-crack resistance.

Mini-DeMattia crack-growth testing was performed on ozone-aged samples that had a crack pre-initiated by pin prick. The results for the Mini-DeMattia are summarized below in tabular format below.

% of Specimen Width Cracked

| | | | | |
|---|---|---|---|---|
| # Cycles | 18000 | — | — | — |
| Compound #2 | | | | |
| Pre-Ozone (Avg) | 97.2 | — | — | — |
| Std. Dev. | 7.9 | — | — | — |
| Post-Ozone (Avg) | 92.2 | — | — | — |
| Std. Dev. | 16.2 | — | — | — |
| # Cycles | 18000 | 54000 | 90000 | 117000 |
| Compound #5 | | | | |
| Pre-Ozone (Avg) | 33.9 | 36.1 | 51.1 | 52.2 |
| Std. Dev. | 41.9 | 40.5 | 42.0 | 41.0 |
| Post-Ozone (Avg) | 62.8 | 81.1 | 85.6 | 85.6 |
| Std. Dev. | 34.6 | 26.4 | 27.9 | 27.9 |
| # Cycles | 18000 | 54000 | 90000 | 135000 |
| Compound #6 | | | | |
| Pre-Ozone (Avg) | 86.7 | 87.8 | 100.0 | 100.0 |
| Std. Dev. | 24.9 | 24.8 | 0.0 | 0.0 |
| Post-Ozone (Avg) | 47.8 | 54.4 | 68.3 | 78.3 |
| Std. Dev. | 33.6 | 31.2 | 32.1 | 21.9 |
| # Cycles | 18000 | 54000 | 90000 | 135000 |
| Compound #8 | | | | |
| Pre-Ozone (Avg) | 48.9 | 56.7 | 71.7 | 90.0 |
| Std. Dev. | 35.0 | 30.8 | 17.8 | 11.3 |
| Post-Ozone (Avg) | 35.6 | 51.7 | 67.8 | 91.1 |
| Std. Dev. | 37.4 | 32.0 | 21.5 | 9.9 |

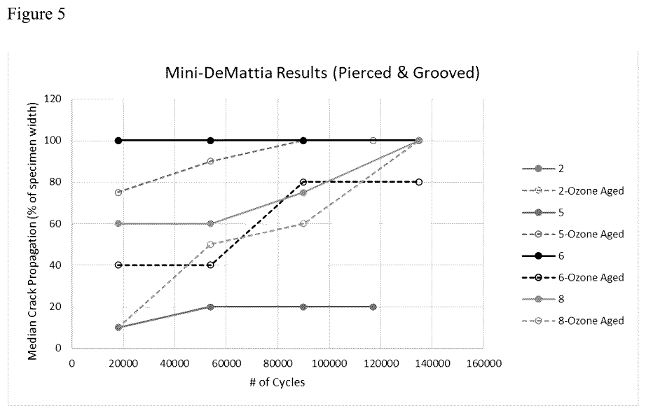

FIG. 5 shows the results of the Mini-DeMattia test in graphical format—demonstrating the cyclical lifetime of each tested sample pre- and post-ozone aging. Comparing the table above and FIG. 5 results in the observation that there is no statistically significant difference between compound 6 (control) and compound 8 (+4.5 PHR MR −14 PHR CB-Wax-TMQ) post-ozone aging. Pre-ozone aging, there is a definitive improvement in the MR sample, as compound 6 failed within the first 18,000 cycles.

The static ozone resistance test, ASTM 1149, Method A, demonstrates that the use of more antioxidants and waxes, in combination with the crack resistance of the Molecular Rebar, can provide equivalent ozone resistance as 6PPD with standard carbon black reinforcing filler, the state-of-the-art. The use of the Mini-DeMattia test confirms the technical feasibility of this proposed MR+antioxidant approach, as the overall post-ozone-aged cyclic lifetime of the MR+antioxidant sample was within the range of error to the state-of-the-art 6PPD+carbon black compound.

The results shown in this example clearly indicate that the use of Molecular Rebar carbon nanotubes results in a tire sidewall composition that is free of 6PPD, while not having any expected detrimental effects on overall tire safety, appearance, or performance.

The disclosed embodiments and aspects of embodiments may relate to the following:

One embodiment of the present invention a composition comprising a plurality of discrete carbon nanotubes, a polymer, and/or an antiozonant wherein a plurality means more discrete nanotubes than not and/or exfoliated useful for replacing all, or a portion of, typical antiozonants or antioxidants in tires or rubber parts.

The polymer used in the invention can be a crosslinked polymer that is an unsaturated natural or synthetic elastomer selected from the group consisting of natural rubbers, polybutadiene, solution polymerized styrene-butadiene rubber, bromobutadiene, styrene butadiene rubber, acetonitrile butadiene, polyisoprene, styrene-isoprene rubbers, ethylene propylene diene rubbers, nitrile rubbers and any mixture thereof.

The carbon nanotubes in the plurality of discrete carbon nanotubes used in the invention are selected from a group consisting of single wall, double wall, multiwall carbon nanotubes, and any mixture thereof.

A majority of the plurality of discrete carbon nanotubes can have a length of greater than about 0.2 micrometers.

The plurality of discrete carbon nanotubes used in the invention can comprise at least a bimodality of length of the plurality of discrete carbon nanotubes.

The carbon nanotubes used in the invention can have chemical surface functionalization, promoting association with the general class of antiozonants or antioxidants, where the chemical functionalization can be selected from the group of molecules that promote van der Waals association or coupling with antiozonants or antioxidants, such as comprising oxygenated species, amine groups, sulfur groups, and azides. The surface functionalization can be present at a concentration of at least 0.05 millimoles of surface functionalization per gram of discrete carbon nanotubes in the composition.

The inventive composition can further comprise a filler, such as those selected from the group consisting of silica, carbon black, oxidized carbon black, recovered carbon black, graphene, turbostratic graphene, carbon fiber, glass fiber, halloysite, clays, and any mixture thereof.

Another embodiment of the inventive composition is where the antiozonant is selected from the class phenylbenzene-diamines (PD), such as 7PPD, 77PD, DPPD, IPPD, CPPD, and 6PPD.

The loading by measure of parts of the carbon nanotubes used in the invention can be between 1 and 30, most preferably between 3 and 12, and wherein the loading by measure of parts of the antiozonant is between 1 and 10, most preferably between 2 and 5.

The inventive composition does not migrate more than ten times, or more than 20 times, or more than 50 times, or more than 75 times, or more than 100 times its length over the composition's lifetime in a tire, and most preferably does not migrate more than five times its length over the composition's lifetime in a tire.

Another embodiment of the inventive composition is that it has a value of ozone resistance, as measured by ASTM D1149 equivalent to a comparable formulation that lacks the plurality of discrete carbon nanotubes.

In addition to the above embodiment, the antiozonant used in the inventive composition can be a less effective antiozonant than a comparable composition's antiozonant, but the inventive composition has a value of ozone resistance, as measured by ASTM D1149 which is substantially equivalent to or better than a comparable formulation that lacks the plurality of discrete carbon nanotubes and utilizes a more effective antiozonant. The less effective antiozonant used in the inventive composition can be 7PPD or 77PD, while the more effective antiozonant, used without carbon nanotubes, in the comparable composition is 6PPD.

Another embodiment is where the inventive composition comprises an additive selected from the group consisting of plasticizers, processing oils, epoxides, crosslinking agents, antioxidants, and any mixture thereof.

On embodiment of the present invention is a composition comprising a plurality of discrete carbon nanotubes, a crosslinked unsaturated natural or synthetic elastomer, and a concentration of less than 0.01 wt % antiozonant, wherein a plurality means more discrete nanotubes than not and/or exfoliated, useful for replacing all, or a substantial portion of, typical antiozonants or antioxidants in tires or rubber parts.

The inventive composition can have a value of ozone resistance, as measured by ASTM D1149, which is substantially equivalent to or better than a comparable formulation that lacks the plurality of discrete carbon nanotubes and utilizes an antiozonant at concentrations greater than 0.01 wt %.

### Embodiments

1. A composition comprising a plurality of discrete carbon nanotubes, a polymer, and/or an antiozonant wherein a plurality means more discrete nanotubes than not and/or exfoliated useful for replacing all, or a portion of, typical antiozonants or antioxidants in tires or rubber parts.
2. The composition of embodiment 1, wherein the composition comprises a crosslinked polymer.
3. The composition of embodiment 1, wherein the composition further comprises an unsaturated natural or synthetic elastomer.
4. The composition of embodiment 3, wherein the natural or synthetic elastomer is selected from the group consisting of natural rubbers, polybutadiene, solution polymerized styrene-butadiene rubber, bromobutadiene, styrene butadiene rubber, acetonitrile butadiene, polyisoprene, styrene-isoprene rubbers, ethylene propylene diene rubbers, nitrile rubbers and any mixture thereof.
5. The composition of embodiment 1 wherein the carbon nanotubes in the plurality of discrete carbon nanotubes are selected from a group consisting of single wall, double wall, multiwall carbon nanotubes, and any mixture thereof.
6. The composition of embodiment 1, wherein a majority of the plurality of discrete carbon nanotubes have a length of greater than about 0.2 micrometers.
7. The composition of embodiment 1, wherein the plurality of discrete carbon nanotubes comprises at least a bimodality of length of the plurality of discrete carbon nanotubes.
8. The composition of embodiment 1, wherein the carbon nanotubes have chemical surface functionalization, promoting association with the general class of antiozonants or antioxidants.
9. The composition of embodiment 8, wherein the surface functionalization is selected from the group of molecules that promote van der Waals association or coupling with antiozonants or antioxidants, such as comprising oxygenated species, amine groups, sulfur groups, and azides.
10. The composition of embodiment 1, wherein the surface functionalization is present at a concentration of at least 0.05 millimoles of surface functionalization per gram of discrete carbon nanotubes in the composition.
11. The composition of embodiment 1, wherein the composition further comprises a filler.
12. The composition of embodiment 11, wherein the filler is selected from the group consisting of silica, carbon black, oxidized carbon black, recovered carbon black, graphene, turbostratic graphene, carbon fiber, glass fiber, halloysite, clays, and any mixture thereof.
13. The composition of embodiment 1, wherein the antiozonant is selected from the class phenylbenzene-diamines (PD), such as 7PPD, 77PD, DPPD, IPPD, CPPD, and 6PPD.
14. The composition of embodiment 1, wherein the loading by measure of parts of the carbon nanotubes is between 1 and 30, most preferably between 3 and 12, and wherein the loading by measure of parts of the antiozonant is between 1 and 10, most preferably between 2 and 5.
15. The composition of embodiment 14 wherein the composition does not migrate more than ten times, or more than 20 times, or more than 50 times, or more than 75 times, or more than 100 times its length over the composition's lifetime in a tire.
16. The composition of embodiment 14 wherein the composition preferably does not migrate more than five times its length over the composition's lifetime in a tire.
17. The composition of embodiment 14, wherein the composition has a value of ozone resistance, as measured by ASTM D1149 equivalent to a comparable formulation that lacks the plurality of discrete carbon nanotubes.
18. The composition of embodiment 14, where the antiozonant used in the embodimented composition is a less effective antiozonant than a comparable composition's antiozonant, but the embodimented composition has a value of ozone resistance, as measured by ASTM D1149 which is substantially equivalent to or better than a comparable formulation that lacks the plurality of discrete carbon nanotubes and utilizes a more effective antiozonant.
19. The composition of embodiment 16, where in the less effective antiozonant used in the embodimented composition is 7PPD or 77PD, while the more effective antiozonant, used without carbon nanotubes, in the comparable composition is 6PPD.
20. The composition of embodiment 1, further comprising an additive selected from the group consisting of plasticizers, processing oils, epoxides, crosslinking agents, antioxidants, and any mixture thereof.
21. A composition comprising a plurality of discrete carbon nanotubes, a crosslinked unsaturated natural or synthetic elastomer, and a concentration of less than 0.01 wt % antiozonant, wherein a plurality means more discrete nanotubes than not and/or exfoliated, useful for replacing all, or a substantial portion of, typical antiozonants or antioxidants in tires or rubber parts.
22. The composition of embodiment 21, wherein the natural or synthetic elastomer is selected from the group consisting of natural rubbers, polybutadiene, solution polymerized styrene-butadiene rubber, bromobutadiene, styrene butadiene rubber, acetonitrile butadiene, polyisoprene, styrene-isoprene rubbers, ethylene propylene diene rubbers, nitrile rubbers and any mixture thereof.
23. The composition of embodiment 21 wherein the carbon nanotubes in the plurality of discrete carbon nanotubes are selected from a group consisting of single wall, double wall, multiwall carbon nanotubes, and any mixture thereof.
24. The composition of embodiment 21, wherein a majority of the plurality of discrete carbon nanotubes have a length of greater than about 0.2 micrometers.
25. The composition of embodiment 21, wherein the composition further comprises a filler selected from the group consisting of silica, carbon black, oxidized carbon black, recovered carbon black, graphene, turbostratic graphene, carbon fiber, glass fiber, halloysite, clays, and any mixture thereof.
26. The composition of embodiment 21, wherein the antiozonant is selected from the class phenylbenzene-diamines (PD), such as 7PPD, 77PD, DPPD, IPPD, CPPD, and 6PPD.
27. The composition of embodiment 21, wherein the loading by measure of parts of the carbon nanotubes is between 1 and 30, most preferably between 3 and 12.
28. The composition of embodiment 27, wherein the composition has a value of ozone resistance, as measured by ASTM D1149 equivalent to a comparable formulation that lacks the plurality of discrete carbon nanotubes.
29. The composition of embodiment 27, where the embodimented composition has a value of ozone resistance, as measured by ASTM D1149, which is substantially equivalent to or better than a comparable formulation that lacks the plurality of discrete carbon nanotubes and utilizes an antiozonant at concentrations greater than 0.01 wt %.
30. The composition of embodiment 21, further comprising an additive selected from the group consisting of plasticizers, processing oils, epoxides, crosslinking agents, antioxidants, and any mixture thereof.

The above description is for the purpose of teaching the person of ordinary skill in the art how to practice the present application, and it is not intended to detail all those obvious modifications and variations of it which will become apparent to the skilled worker upon reading the description. It is intended, however, that all such obvious modifications and variations be included within the scope of the present application, which is defined by the following claims. The claims are intended to cover the claimed components and steps in any sequence which is effective to meet the objectives there intended, unless the context specifically indicates the contrary

We claim:

1. A composition comprising a plurality of discrete carbon nanotubes, a polymer, and/or an antiozonant wherein a plurality means more discrete nanotubes than not and/or exfoliated useful for replacing all, or a portion of, typical antiozonants or antioxidants in tires or rubber parts.

2. The composition of claim 1, wherein the polymer comprises a crosslinked polymer.

3. The composition of claim 1, wherein the composition further comprises an unsaturated natural elastomer, an unsaturated synthetic elastomer, or any combination thereof.

4. The composition of claim 3, wherein the natural elastomer or the synthetic elastomer is selected from the group consisting of natural rubbers, polybutadienes, solution polymerized styrene-butadiene rubbers, bromobutadiene, styrene butadiene rubbers, acetonitrile butadienes, polyisoprenes, styrene-isoprene rubbers, ethylene propylene diene rubbers, nitrile rubbers and any mixture thereof.

5. The composition of claim 1 wherein the carbon nanotubes in the plurality of discrete carbon nanotubes are selected from a group consisting of single wall, double wall, multiwall carbon nanotubes, and any mixture thereof.

6. The composition of claim 1, wherein a majority of the plurality of discrete carbon nanotubes have a length of greater than about 0.2 micrometers.

7. The composition of claim 1, wherein the plurality of discrete carbon nanotubes comprises at least a bimodal distribution of length.

8. The composition of claim 1, wherein the plurality of discrete carbon nanotubes are surface functionalized with a moiety that promotes association with an antiozonant, an antioxidant, or both.

9. The composition of claim 8, wherein the moiety is selected from oxygenated species, amine groups, sulfur groups, azides, or any combination thereof.

10. The composition of claim 8, wherein the surface functionalization is present at a concentration of at least about 0.05 millimoles of surface functionalization per gram of discrete carbon nanotubes in the composition.

11. The composition of claim 1, wherein the composition further comprises a filler.

12. The composition of claim 11, wherein the filler is selected from the group consisting of silica, carbon black, oxidized carbon black, recovered carbon black, graphene, turbostratic graphene, carbon fiber, glass fiber, halloysite, clays, and any mixture thereof.

13. The composition of claim 1, wherein the antiozonant is 7PPD, 77PD, DPPD, IPPD, CPPD, 6PPD, or any combination thereof.

14. The composition of claim 1, wherein the carbon nanotubes comprise from about 1 to about 30 parts of the total composition and wherein the antiozonant comprises from about 1 and about 10 parts of the total composition.

15. The composition of claim 14 wherein the composition is employed in a tire and wherein the plurality of carbon nanotubes in the composition migrates less than 100 times its average length in the tire.

16. The composition of claim 15 wherein the composition migrates less than five times its average length.

17. The composition of claim 14, wherein the composition has a value of ozone resistance, as measured by ASTM D1149 that is substantially equivalent to or better than a comparable formulation that lacks the plurality of discrete carbon nanotubes.

18. The composition of claim 14, wherein composition has a value of ozone resistance, as measured by ASTM D1149 that is substantially equivalent to or better than a comparable formulation that lacks the plurality of discrete carbon nanotubes and utilizes a more effective antiozonant.

19. The composition of claim 18, wherein the more effective antiozonant utilized in the comparable composition is 6PPD.

20. The composition of claim 1, further comprising an additive selected from the group consisting of plasticizers, processing oils, epoxides, crosslinking agents, antioxidants, and any mixture thereof.

21. A composition comprising a plurality of discrete carbon nanotubes, a crosslinked unsaturated natural elastomer or crosslinked unsaturated synthetic elastomer or a combination thereof, and a concentration of less than 0.01 wt % antiozonant, wherein a plurality means more discrete nanotubes than not and/or exfoliated, useful for replacing all, or a substantial portion of, typical antiozonants or antioxidants in tires or rubber parts.

22. The composition of claim 21, wherein the natural elastomer or synthetic elastomer is selected from the group consisting of natural rubbers, polybutadienes, solution polymerized styrene-butadiene rubbers, bromobutadienes, styrene butadiene rubbers, acetonitrile butadienes, polyisoprenes, styrene-isoprene rubbers, ethylene propylene diene rubbers, nitrile rubbers and any mixture thereof.

23. The composition of claim 21 wherein the carbon nanotubes in the plurality of discrete carbon nanotubes are selected from a group consisting of single wall, double wall, multiwall carbon nanotubes, and any mixture thereof.

24. The composition of claim 21, wherein a majority of the plurality of discrete carbon nanotubes have a length of greater than about 0.2 micrometers.

25. The composition of claim 21, wherein the composition further comprises a filler selected from the group consisting of silica, carbon black, oxidized carbon black, recovered carbon black, graphene, turbostratic graphene, carbon fiber, glass fiber, halloysite, clays, and any mixture thereof.

26. The composition of claim 21, wherein the antiozonant is selected from the 7PPD, 77PD, DPPD, IPPD, CPPD, 6PPD, or any mixture thereof.

27. The composition of claim 21, wherein the carbon nanotubes comprise from about 1 and 30 parts of the total composition.

28. The composition of claim 27, wherein the composition has a value of ozone resistance, as measured by ASTM D1149 that is substantially equivalent to or better than a comparable formulation that lacks the plurality of discrete carbon nanotubes.

29. The composition of claim 27, where the claimed composition has a value of ozone resistance, as measured by ASTM D1149, which is substantially equivalent to or better than a comparable formulation that lacks the plurality of discrete carbon nanotubes and utilizes a more effective antiozonant at a concentrations greater than 0.01 wt % based on the weight of the total composition.

30. The composition of claim 21, further comprising an additive selected from the group consisting of plasticizers, processing oils, epoxides, crosslinking agents, antioxidants, and any mixture thereof.
